(19) United States
(12) Patent Application Publication
(10) Pub. No.: US 2002/0071058 A1
(43) Pub. Date: Jun. 13, 2002

(54) Communication terminal apparatus

(76) Inventor: Hirofumi Shimuzu, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/964,466

(22) Filed: Sep. 28, 2001

(30) Foreign Application Priority Data
Dec. 7, 2000 (JP) 2000-373256

(51) Int. Cl. H04N 5/58

(52) U.S. Cl. 348/602

(57) ABSTRACT

When reception of an E-mail or browser data on a Web site from a network has been completed, a controller informs the user of the completion of the data reception by turning on the backlight of a display section or sounding a sounding device, on the basis of information set in an informing-operation-setup-table storage area, more specifically, on the basis of the ambient brightness detected by a sensor or a present time point detected by a timer.

### CROSS-REFERENCE TO RELATED APPLICATIONS

This application is based upon and claims the benefit of priority from the prior Japanese Patent Application No. 2000-373256, filed Dec. 7, 2000, the entire contents of which are incorporated herein by reference.

### BACKGROUND OF THE INVENTION

1. Field of the Invention

The present invention relates to a wired or wireless communication terminal apparatus including a display section provided with illumination means such as a backlight.

2. Description of the Related Art

As well known, a telephone connected to a public network by a cable, or a mobile radio terminal, such as a mobile phone, includes a display section provided with a backlight that enhances its visibility.

The backlight is designed to be automatically turned off to save power, if the apparatus is not operated for a predetermined period of time.

Recently, such telephones or mobile radio terminal apparatuses have come to be loaded with a function of sending/receiving E-mails and/or accessing Web sites on the Internet.

Also when using the function, the backlight is automatically turned off to thereby save power, if the user does not operate the apparatus for a predetermined time period. If, for example, a lot of time is required to receive information, the backlight will be turned off even while the function is being executed.

This being so, in a dark place, the user has to turn on the backlight so as to read the received information if it is in the OFF state. This is inconvenient for the user. Further, it is possible that the user turns on the backlight before information is completely received, which increases the consumption of power.

Moreover, in the conventional case, the backlight is automatically turned on if the user executes a predetermined operation. Accordingly, even in the daytime or in a bright place, the backlight may be unnecessarily turned on to thereby consume extra power.

### BRIEF SUMMARY OF THE INVENTION

The present invention has been developed to solve the above-described problems, and aims to provide a communication terminal apparatus that is very convenient when receiving information and is free from unnecessary turn-on of its backlight, thereby saving power.

To satisfy the aim, according to a first aspect of the invention, there is provided a communication terminal apparatus capable of receiving information from a communication system network, comprising: receiving means for receiving information from the network; a display configured to display information; illumination means for illuminating the display; a detector configured to detect completion of information reception by the receiving means; display control means for causing the display to display information received by the receiving means, when the detector has detected the completion of the information reception; and a illumination controller configured to cause the illumination means to illuminate the display, when the detector has detected the completion of the information reception.

In the communication terminal apparatus constructed as above, the illumination means is controlled so as to illuminate the display means when reception of information from a network has been completed.

According to a second aspect of the invention, there is provided a communication terminal apparatus capable of receiving information from a communication system network, comprising: receiving means for receiving information from the network; a display configured to display information; illumination means for illuminating the display; illumination detecting means for detecting an intensity of illumination; a detector configured to detect completion of information reception by the receiving means; display control means for causing the display to display information received by the receiving means, when the detector has detected the completion of the information reception; and a illumination controller configured to cause the illumination means to illuminate the display, when the detector has detected the completion of the information reception, and the intensity of illumination detected by the illumination detecting means is not more than a predetermined value.

In the communication terminal apparatus constructed as above, the illumination means is controlled so as to illuminate the display means, when reception of information from a network has been completed, and the ambient illumination is not more than a predetermined value.

According to a third aspect of the invention, there is provided a communication terminal apparatus capable of receiving information from a communication system network, comprising: receiving means for receiving information from the network; a display configured to display information; illumination means for illuminating the display; timer means for measuring time; a detector configured to detect completion of information reception by the receiving means; display control means for causing the display to display information received by the receiving means, when the detector has detected the completion of the information reception; and a illumination controller configured to cause the illumination means to illuminate the display, when the detector has detected the completion of the information reception, and a time point detected by the timer means falls within a predetermined time period.

In the communication terminal apparatus constructed as above, the illumination means is controlled so as to illuminate the display means, when reception of information from a network has been completed, and a time point detected by the timer means falls within a predetermined time period.

According to a fourth aspect of the invention, there is provided a communication terminal apparatus capable of receiving information from a communication system network, comprising: receiving means for receiving information from the network; a display configured to display information; illumination means for illuminating the display; display control means for causing the display to display information received by the receiving means; and a illumination controller configured to cause the illumination means to illuminate the display, when the display control means has started display of information on the display.

In the communication terminal apparatus constructed as above, the illumination means is controlled so as to illuminate the display means when information received from a network is started to be displayed on the display means.

According to a fifth aspect of the invention, there is provided a communication terminal apparatus capable of receiving information from a communication system network, comprising: receiving means for receiving information from the network; a display configured to display information; illumination means for illuminating the display; illumination detecting means for detecting an intensity of illumination; display control means for causing the display to display information received by the receiving means, when the detector has detected the completion of the information reception; and a illumination controller configured to cause the illumination means to illuminate the display, when the display control means has started display of information on the display, and the intensity of illumination detected by the illumination detecting means is not more than a predetermined value.

In the communication terminal apparatus constructed as above, the illumination means is controlled so as to illuminate the display means, when information received from a network is started to be displayed on the display means, and the ambient illumination is not more than a predetermined value.

According to a sixth aspect of the invention, there is provided a communication terminal apparatus capable of receiving information from a communication terminal apparatus capable of receiving information from a communication system network, comprising: receiving means for receiving information from the network; a display configured to display information; illumination means for illuminating the display; timer means for measuring time; display control means for causing the display to display information received by the receiving means; and a illumination controller configured to cause the illumination means to illuminate the display, when the display control means has started display of information on the display, and a time point detected by the timer means falls within a predetermined time period.

In the communication terminal apparatus constructed as above, the illumination means is controlled so as to illuminate the display means, when information received from a network is started to be displayed on the display means, and a time point detected by the timer means falls within a predetermined time period.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a circuit diagram illustrating a communication terminal apparatus according to an embodiment of the invention;

FIG. 2 is a view illustrating information stored in a warning-operation setup table storage area that is incorporated in the communication terminal apparatus of FIG. 1;

FIG. 3 is a flowchart useful in explaining a process of setting information to be stored in the warning-operation setup table storage area of FIG. 2;

FIG. 4 is a view illustrating example information displayed, when executing the process of FIG. 3, on a display section incorporated in the communication terminal apparatus of FIG. 1;

FIG. 5 is a view illustrating example information displayed, when executing the process of FIG. 3, on a display section incorporated in the communication terminal apparatus of FIG. 1;

FIG. 6 is a view illustrating example information displayed, when executing the process of FIG. 3, on a display section incorporated in the communication terminal apparatus of FIG. 1; and

FIG. 7 is a flowchart useful in explaining the operation of the communication terminal apparatus executed when data has been completely received.

### DETAILED DESCRIPTION OF THE INVENTION

An embodiment of the invention will be described with reference to the accompanying drawings.

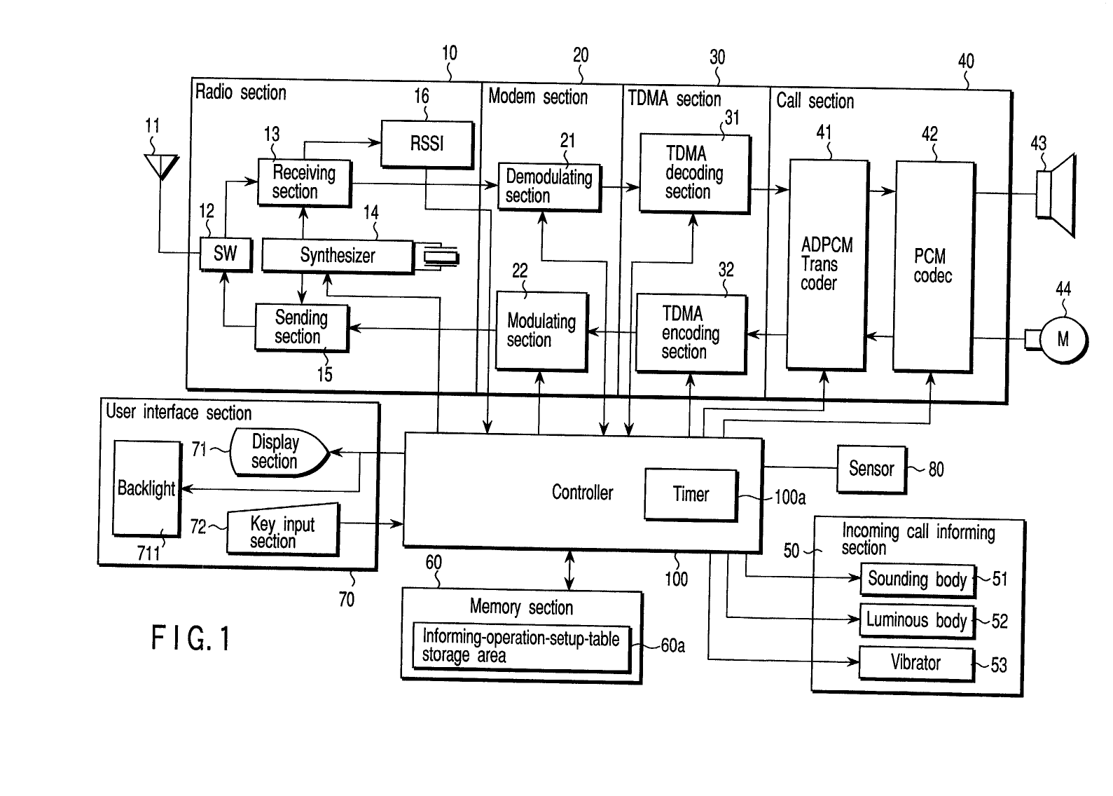

FIG. 1 shows a communication terminal apparatus according to an embodiment of the invention. In this embodiment, a description will be given of a mobile radio terminal apparatus as an example, which is incorporated in a mobile phone system that executes radio communication to and from a base station connectable to a network, using the TDMA (Time Division Multiple Access) system.

The mobile radio terminal apparatus shown in FIG. 1 comprises a radio section 10 provided with an antenna 11, a modem section 20, a TDMA section 30, a call section 40 provided with a speaker 43 and a microphone 44 (M), an incoming call informing section 50, a memory section 60, a user interface section 70, a sensor 80 and a controller 100.

A radio frequency signal, sent via a radio call channel from the base station connected to a mobile communication network, is received by the antenna 11, and then input to a receiving section 13 via a high frequency switch (SW) 12, which are incorporated in the radio section 10.

The receiving section 13 mixes the received radio frequency signal with a local oscillation signal generated by a frequency synthesizer 14, thereby converting it into an intermediate frequency signal.

A local oscillation frequency generated from the frequency synthesizer 14 is controlled by the controller 100 in accordance with the radio channel frequency. The radio section 10 also includes a received-electric-field-intensity detector (RSSI) 16.

The received-electric-field-intensity detector 16 detects the electric field intensity (hereinafter referred to as “RSSI”) of a radio frequency signal sent from the base station, and supplies the detected value to the controller 100.

A demodulator 21 incorporated in the modem section 20 receives the intermediate frequency signal output from the receiving section 13, and subjects the received signal to digital demodulation, thereby reproducing a digital call signal.

A TDMA decoding section 31 incorporated in the TDMA section 30 separates, under the control of the controller 100, the digital call signal into a plurality of digital call signals corresponding to respective time slots. That one of the thus-obtained digital call signals, which corresponds to the slot assigned to the communication terminal apparatus called, is input to the call section 40.

The call section 40 comprises an adaptive difference PCM trans coder (ADPCM TRANS CODER) 41 and a PCM codec (PCM CODEC) 42. The adaptive difference PCM trans coder 41 and the PCM codec 42 sequentially decode the digital call signal, thereby converting it into an analog call signal. The analog call signal is amplified by a call signal amplifier (not shown) and output from the speaker 43 in the form of sound.

On the other hand, a to-be-sent sound received by the microphone 44 is sequentially encoded by the PCM codec 42 and the adaptive difference PCM trans coder 41, thereby being converted into a digital call signal. The resultant digital signal is input to a TDMA encoding section 32.

The TDMA encoding section 32 inserts the digital call signal from the adaptive difference trans coder 41 into a time slot designed by the controller 100, and supplies it to a modulating section 22. The modulating section 22 subjects a carrier signal to digital modulation, using the digital call signal. The thus-modulated carrier signal is input to a sending section 15.

The sending section 15 mixes the modulated carrier signal with a local oscillation signal generated by the frequency synthesizer 14, subjects the resultant signal to frequency conversion to obtain a radio channel frequency designated by the controller 100, and amplifies the resultant signal to a predetermined transmission power level. The radio frequency signal, resulting from the frequency conversion and signal amplification by the sending section 15, is input to the high frequency switch 12 and then transmitted from the antenna 11 to the base station.

The incoming call informing section 50 informs the user of an incoming call, if there is one. The informing section 50 includes a sounding device 51 configured to inform the user of an incoming call by generating an audible sound, a luminous body 52 configured to execute the informing operation by emitting light, and a vibrator 53, such as an eccentric motor, configured to execute the informing operation by generating a vibration.

The memory section 60 is formed of, for example, a semiconductor memory, such as a ROM or a RAM, which stores a control program used in the controller 100, ID data necessary to identify the apparatus itself, various types of control data, various types of setup data, and E-mails created or received, etc. The memory section 60 includes an informing-operation-setup-table storage area 60a.

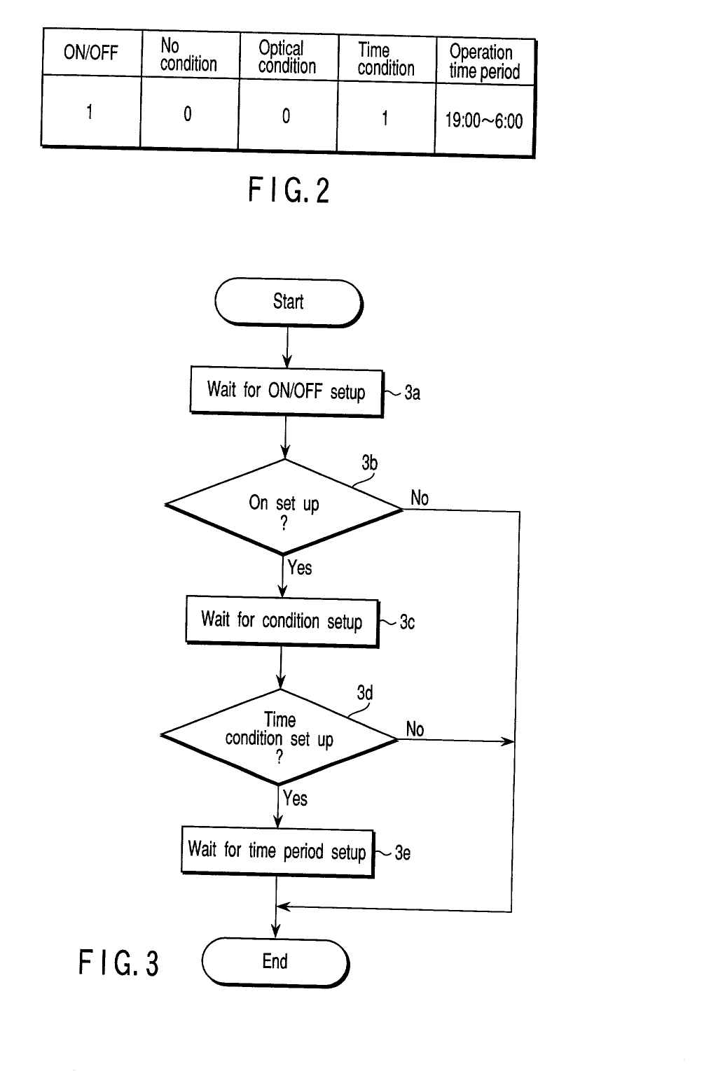

The informing-operation-setup-table storage area 60a is an area that stores information concerning setup conditions of the informing operation, which is executed when data sent from a network via the base station has been received by the communication terminal apparatus. Specifically, as shown in FIG. 2, the area 60 stores “ON/OFF” information indicative of whether or not the informing operation should be executed, information indicative of a condition (TIME CONDITION, OPTICAL CONDITION, NO CONDITION) for the informing operation, and information indicative of the time period of the informing operation, which is set if the time condition is selected.

The user interface section 70 includes a display section 71 and a key input section 72. The display section 71 is formed of an LCD (Liquid Crystal Display) equipped with a backlight 711. The user interface section 70 can display information based on data received from a network via the base station, and is used to show the user the state of the communication terminal apparatus itself (a calling state/a called state; a residual battery amount; a received signal intensity), dial data read from the memory section 60, text data such as E-mails, and image data, etc.

The key input section 72 includes a key pad, such as a ten-key pad, used to execute standard call functions related to signal sending/receiving operations, and a key (or keys) used to switch the incoming-call informing methods (audible sound generation/light emission/vibration/no informing operation), and a key (or keys) used to execute various types of setups or functions, such as code input for selecting an incoming call sound, an incoming call melody, etc. These keys can be used as character input keys when creating an E-mail.

The sensor 80 detects the illumination of the ambient light in the vicinity of the communication terminal apparatus, and outputs the detected illumination data (hereinafter referred to “illumination data”) to the controller 100.

The controller 100 includes a main control section realized by, for example, a microcomputer, and controls the above-described elements. Specifically, the controller 100 provides a time measurement function, using a timer 100a, a control function of executing voice communication or sending/receiving E-mails, using the aforementioned TDMA system, and a control function of accessing Web sites using Web browser software.

The controller 100 also provides a control function of informing, when reception of an E-mail or browser data on a Web site from a network has been completed, the user of it by lighting the backlight 711 of the display section 71 or sounding the sounding device 51.

Although FIG. 1 does not show it, the communication terminal apparatus also comprises a power section including a rechargeable battery that powers the above-described elements.

A description will now be given of the operation of the mobile radio terminal apparatus constructed as above. In the following description, only the operations related to the present invention will be described, while others, related to standard communication functions, will be omitted. These operations are executed under the control of the controller 100.

Referring first to the flowchart of FIG. 3, a description will be given of a process of setting, for example, informing operation conditions when data reception has been completed.

When the user has requested the setup of the informing operation conditions, using the key input section 72, the following process is started.

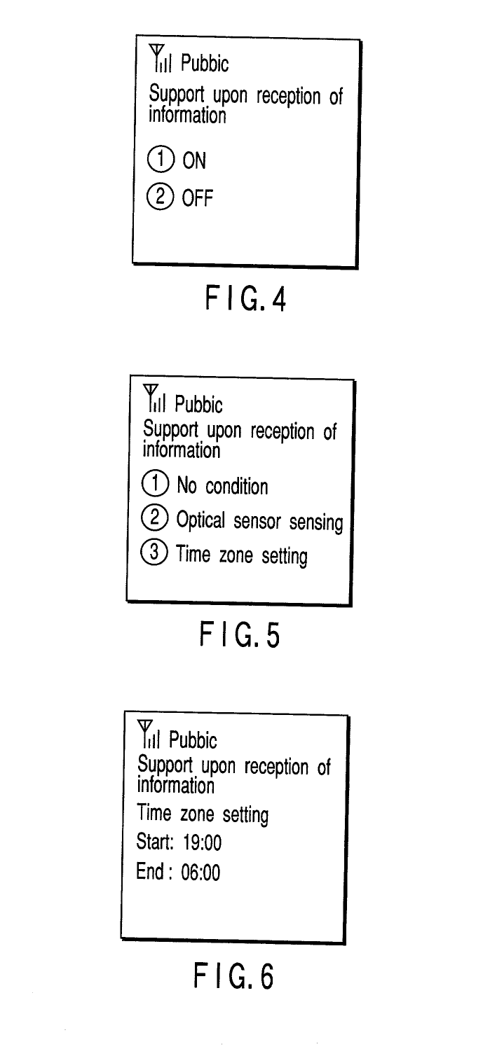

First, at step 3a, an image as shown in FIG. 4 is displayed on the display section 71, thereby waiting for the user to operate the key input section 72 and input information as to whether or not the informing operation, such as light-up control of the backlight 711 of the display section 71 or driving control of the sounding device 51, should be executed when data reception has been completed. Then, the program proceeds to step 3b.

If there is a request for executing the informing operation, “1” is set in the column of “ON/OFF” in the informing-operation-setup-table storage area 60a shown in FIG. 2. If, on the other hand, there is a request for inhibiting the informing operation, “0” is set in the column.

At the step 3b, it is determined whether or not “1” is set in the “ON/OFF” column of the informing-operation-setup-table storage area 60a, i.e. whether or not it is set up that the information operation should be executed.

If the answer at the step 3b is YES (ON setup), the program proceeds to step 3c, whereas if the answer is NO (i.e. “0” is set so as to inhibit the informing operation; OFF setup), the program is terminated.

At the step 3c, an image as shown in FIG. 5 is displayed on the display section 71, thereby waiting for the user to operate the key input section 72 and input information as to in which condition the informing operation should be executed. Then, the program proceeds to step 3d.

If there is a request for \mathring{3} “TIME ZONE SETTING”, i.e. “TIME CONDITION”, “1” is set in the column of “time condition” and “0” is set in the other columns in the informing-operation-setup-table storage area 60a shown in FIG. 2.

If there is a request for \mathring{2} “OPTICAL SENSOR SENSING”, i.e. “OPTICAL CONDITION”, “1” is set in the column of “OPTICAL CONDITION” and “0” is set in the other columns in the informing-operation-setup-table storage area 60a shown in FIG. 2.

Further, if there is a request for \mathring{1} “NO CONDITION”, “1” is set in the column of “NO CONDITION” and “0” is set in the other columns in the informing-operation-setup-table storage area 60a shown in FIG. 2.

At the step 3d, it is determined whether or not “1” is set in the “TIME CONDITION” column of the informing-operation-setup-table storage area 60a. If “1” is set in the column, the program proceeds to step 3e, whereas if “0” is set in the column, the program is terminated.

At the step 3e, an image as shown in FIG. 6 is displayed on the display section 71, thereby waiting for the user to operate the key input section 72 and input information as to a time period in which the informing operation should be executed. The input time period is set in the “OPERATION TIME PERIOD” column of the informing-operation-setup-table storage area 60a, thereby terminating the program.

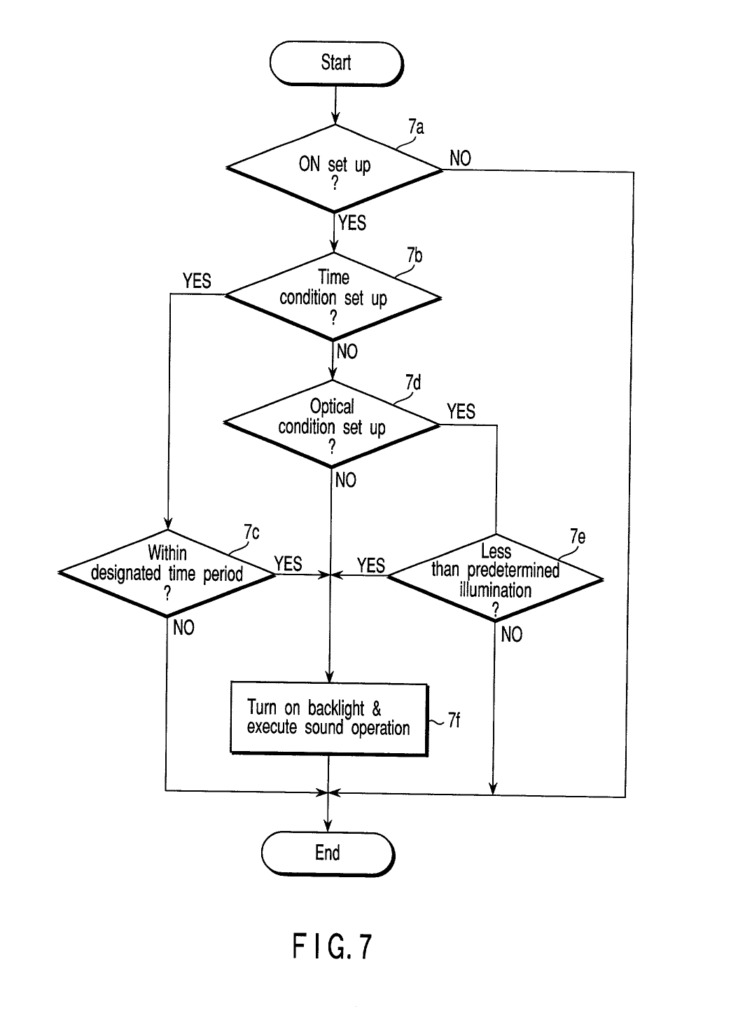

Referring then to the flowchart of FIG. 7, the operation executed when data reception has been completed will be described. When the controller 100 has detected the completion of reception of data, such as an E-mail or browser data on a Web site from a network, it executes the operation shown in FIG. 7. After the completion of data reception, the controller 100 executes a display operation, as well as the above operation, thereby executing a display based on the received data.

First, at step 7a, it is determined whether or not “1” is set in the “ON/OFF” column of the informing-operation-setup-table storage area 60a, i.e. whether or not it is set up that the information operation should be executed.

If the answer at the step 3b is YES (ON setup), the program proceeds to step 7b, whereas if the answer is NO (OFF setup), the program is terminated without executing the informing operation.

At the step 7b, it is determined whether or not “1” is set in the “TIME CONDITION” column of the informing-operation-setup-table storage area 60a. If “1” is set in the column, the program proceeds to step 7c, whereas if “0” is set in the column, the program proceeds to step 7d.

At the step 7c, it is determined whether or not the present time point detected by the timer 100a falls within a time period set in the “OPERATION TIME PERIOD” column of the informing-operation-setup-table storage area 60a.

If the present time point falls within the set time period, the program proceeds to step 7f, whereas if it falls outside the set time period, the program is terminated without executing the informing operation.

At the step 7d, it is determined whether or not “1” is set in the “OPTICAL CONDITION” column of the informing-operation-setup-table storage area 60a. If “1” is set in the column, the program proceeds to step 7e, whereas if “0” is set in the column, the program proceeds to the step 7f.

At the step 7e, it is determined whether or not the intensity of illumination indicated by illumination data obtained by the sensor 80 is not more than a predetermined value.

If the illumination intensity indicated by the illumination data from the sensor 80 is not more than the predetermined value, the program proceeds to the step 7f. If, on the other hand, it is more than the predetermined value, the program is terminated without the informing operation.

At the step 7f, the backlight 711 of the display section 71 is turned on, and the sounding device 51 is driven to generate a sound, so as to inform the user that data reception has been completed, thereby terminating the program.

As described above, in the communication terminal apparatus of the present invention, the backlight 711 is automatically turned on when data reception has been completed to thereby enable the user to see the received data. Therefore, the user does not have to operate the terminal apparatus when data reception has been completed. Further, in this structure, the backlight 711 is not unnecessarily turned on. As a result, the communication terminal apparatus is very convenient for the user when receiving data, and requires less power.

Furthermore, if the user selects “TIME CONDITION” as the informing operation condition, they are informed of the completion of data reception, only in a necessary time period, by the turn-on of the backlight 711 of the display section 71 or the sounding operation of the sounding device 51. Thus, the communication terminal apparatus can be adjusted in accordance with the user's life style or circumstances in which they use the apparatus. As a result, unnecessary turn-on of the backlight 711 can be avoided.

Similarly, if the user selects “OPTICAL CONDITION” as the informing operation condition, they are informed of the completion of data reception by the turn-on of the backlight 711 or the sounding operation of the sounding device 51, only when the ambient illumination is at a low level and the backlight 711 should be turned on. Thus, the communication terminal apparatus can be adjusted in accordance with the circumstances in which they use the apparatus. As a result, unnecessary turn-on of the backlight 711 can be avoided.

The present invention is not limited to the above-described embodiment. For example, although in the embodiment, the turn-on of the backlight 711 of the display section 71 and the sounding operation of the sounding device 51 are used as informing operations, the light emission of the luminous body 52 and the vibration of the vibrator 53 can be used as informing operations in place of the first-mentioned operations.

Moreover, although in the embodiment, the backlight 711 is automatically turned on upon completion of data reception, it may be designed to be automatically turned on under the control of the controller 100 at the start of display of data received.

Also in this type of control, the backlight 711 may be automatically turned on only if the illumination detected by the sensor 80 is not more than a predetermined value. Alternatively, such automatic turn-on of the backlight 711 may be performed only in a predetermined time period.

In addition, the turn-on of the backlight 711 of the display section 71 and the sounding operation of the sounding device 51 (or the aforementioned emission of the luminous body 52 and vibration of the vibrator 53) are not necessarily executed simultaneously, but may be selectively executed.

Although in the embodiment, the backlight 711 is used as means for illuminating the display section 71, a sidelight may be employed instead of the backlight.

It is a matter of course that the present invention can be modified in various manners without departing from its scope.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication terminal apparatus capable of receiving information from a communication system network, comprising:
receiving means for receiving information from the network;
a display configured to display information;
illumination means for illuminating the display;
a detector configured to detect completion of information reception by the receiving means;
display control means for causing the display to display information received by the receiving means, when the detector has detected the completion of the information reception; and
a illumination controller configured to cause the illumination means to illuminate the display, when the detector has detected the completion of the information reception.

2. A communication terminal apparatus capable of receiving information from a communication system network, comprising:
receiving means for receiving information from the network;
a display configured to display information;
illumination means for illuminating the display;
illumination detecting means for detecting an intensity of illumination;
a detector configured to detect completion of information reception by the receiving means;
display control means for causing the display to display information received by the receiving means, when the detector has detected the completion of the information reception; and
a illumination controller configured to cause the illumination means to illuminate the display, when the detector has detected the completion of the information reception, and the intensity of illumination detected by the illumination detecting means is not more than a predetermined value.

3. A communication terminal apparatus capable of receiving information from a communication system network, comprising:
receiving means for receiving information from the network;
a display configured to display information;
illumination means for illuminating the display;
timer means for measuring time;
a detector configured to detect completion of information reception by the receiving means;
display control means for causing the display to display information received by the receiving means, when the detector has detected the completion of the information reception; and
a illumination controller configured to cause the illumination means to illuminate the display, when the detector has detected the completion of the information reception, and a time point detected by the timer means falls within a predetermined time period.

4. The communication terminal apparatus according to any one of claims 1-3, further comprising:
sound generating means for generating a sound; and
sound generation control means for causing the sound generating means to generate the sound to thereby inform a user of the completion of the information reception, when the detector has detected the completion of the information reception.

5. A communication terminal apparatus capable of receiving information from a communication system network, comprising:
receiving means for receiving information from the network;
a display configured to display information;
illumination means for illuminating the display;
display control means for causing the display to display information received by the receiving means; and
a illumination controller configured to cause the illumination means to illuminate the display, when the display control means has started display of information on the display.

6. A communication terminal apparatus capable of receiving information from a communication system network, comprising:
receiving means for receiving information from the network;
a display configured to display information;
illumination means for illuminating the display;
illumination detecting means for detecting an intensity of illumination;
display control means for causing the display to display information received by the receiving means, when the detector has detected the completion of the information reception; and
a illumination controller configured to cause the illumination means to illuminate the display, when the display control means has started display of information on the display, and the intensity of illumination detected by the illumination detecting means is not more than a predetermined value.

7. A communication terminal apparatus capable of receiving information from a communication system network, comprising:
receiving means for receiving information from the network;
a display configured to display information;
illumination means for illuminating the display;
timer means for measuring time;
display control means for causing the display to display information received by the receiving means; and
a illumination controller configured to cause the illumination means to illuminate the display, when the display control means has started display of information on the display, and a time point detected by the timer means falls within a predetermined time period.

8. The communication terminal apparatus according to any one of claims 5-7, further comprising:
sound generating means for generating a sound; and
sound generation control means for causing the sound generating means to generate the sound to thereby inform a user of the completion of the information reception, when the display control means has started display of information on the display.
